(19) United States
(12) Patent Application Publication
(10) Pub. No.: US 2004/0160685 A1
(43) Pub. Date: Aug. 19, 2004

(54) Lower rear view mirror (LRVM for short)

(76) Inventor: Everardo Daniel Faires Quiros, Margate, FL (US)

Correspondence Address: Everardo Daniel Faires, 6239 N.W. 17 street, Margate, FL, 33063, US

(21) Appl. No.: 10/746,688

(22) Filed: Dec. 29, 2003

Related U.S. Application Data
(60) Provisional application No. 60/442,546, filed on Jan. 27, 2003.

(51) Int. Cl. G02B 5/08

(52) U.S. Cl. 359/866; 359/838

(57) ABSTRACT

There is a large blind area on vehicles, and the larger the vehicles, (Especially suv's) the larger the area the driver won't be able to see before and while reversing the vehicle.

The blind spot is a dangerous area especially for small children.

These blind area is in the back of all vehicles.

The Lower Rear View Mirror will allow the driver to see this area. By combining spoiler and mirrors in a way that would allow the driver to see clearly, and fully, the driver will be confident and know he or she are backing up safely.

The purpose of the LRVM is to help the driver back up the vehicle safely, confident, easily, and as is usually and normally done. Without discouraging drivers to install and use it.

### BACK GROUND OF THE INVENTION

I am claiming priority status with provisional application #60/442,546. Many children are injure or killed by accident when a vehicle backs up, because the driver can not see the lower rear area behind the vehicle. This area is consider a blind spot.

About 50 children are ran over a year. There are also many rear bumper accidents, mostly in parking lots.

The actual time of the concept for the LRVM was before the expiration date of my application, #60/071,292, granted Mar. 24, 1998. Which was for a provisional application of sensors to assist in backing up.

A patent application did not follow the provisional application, because I thought the LRVM would be better.

The sensors are now in use on some vehicles, as well as cameras. Most of the major auto manufactures are looking for something that will work better and be less expensive.

### BRIEF SUMMARY OF THE INVENTION

The LRVM was made in a way to allow the driver see the most of the rear area of a vehicle with confidence, ease of use, and will be discreet by adding a little style rather then adding something that stands out. It lets the driver see the lower rear area of the vehicle clearly.

This area can not be seen by the driver, if there is a child in this blind spot the driver can not see the child. The bigger the vehicle is the bigger the blind spot will be. The LRVM does not only show the lower rear area of the vehicle to the diver, it also lets the driver see the area to the left and right of the rear. This is also important, because someone, or a car might be heading towards the rear of the vehicle, and another vehicle can be blocking the view, this happens mostly in parking lot.

Unlike the sensors and cameras, because both of them cover a limited area compare to the LRVM. Also the sensor and the cameras can malfunction and mislead the driver. Also with cameras you have to look to the front to see the monitor. The LRVM will allow the driver to see what is in the blind spot constantly while looking backwards to back up. This is important because anything can happen, like a child that was walking or running in was not in the cameras view when the driver was looking at the monitor.

### BRIEF DESCRIPTION OF THE SEVERAL VIEWS OF THE DRAWING

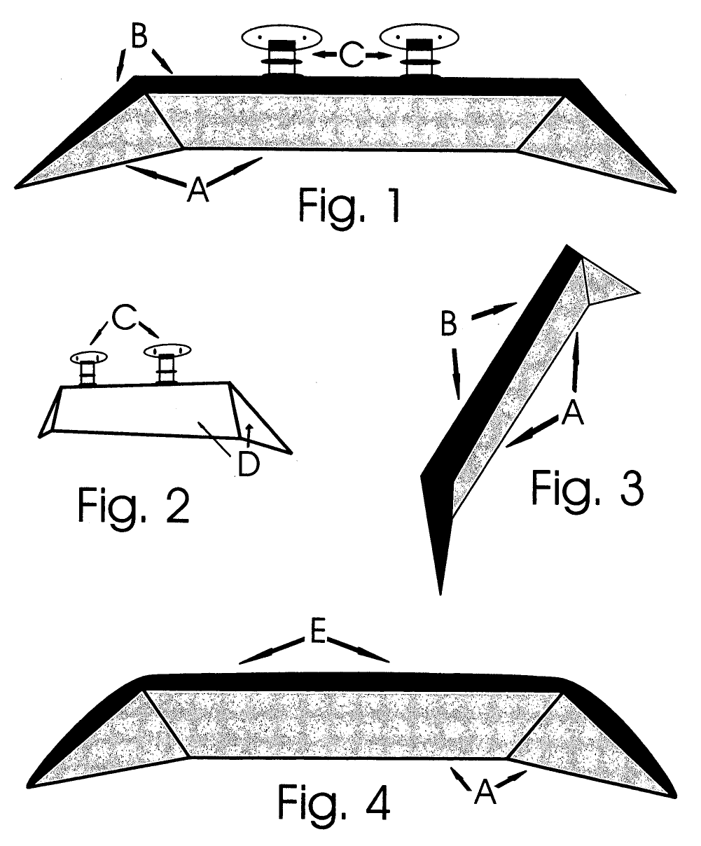

(FIG. 1) a view of the inner side of the (LRVM) Lower Rear View Mirror. The inner side is the part of the LRVM where the mirror part is, the the shaded area indicates the mirror, mirrors (a). (b) shows what would be the bevel rise of the mirror part, were the bottom of the mirror is with less elevation.(c) are two adjustable hinges used to mount the LRVM on the metal above the rear window of the auto.

(FIG. 2) shows a back angle view of(FIG. 1), (d) indicates the outer side.

(FIG. 3) shows an angle top inner side view of FIG. 1 without (c).

(FIG. 4) is the LRVM with the mirror mounted completely flat without any elevation as shown on (FIGS. 1 & 3). (a) indicates the mirror and (e) is the LRVM with an upper lip for another way it can be mounted.

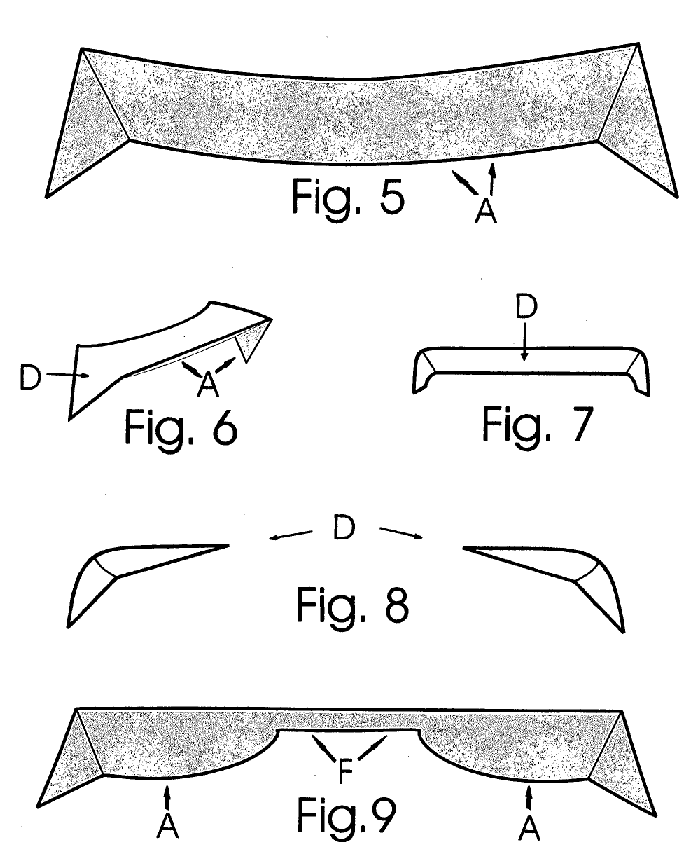

(FIG. 5) the LRVM is shaped curved on top to accommodate to the shape of some rear windows.

(FIG. 6) is an outer angle view of (FIG. 5).

(FIG. 7) another different shape of the LRVM again to accommodate to the many shapes of the windows and doors, it's also smaller for the small windows on some vans and suv's.

(FIG. 8) is two other smaller shapes, which go one on each outer corner of the window.

(FIG. 9) shows the LRVM shaped (f) to permit view of brake light.

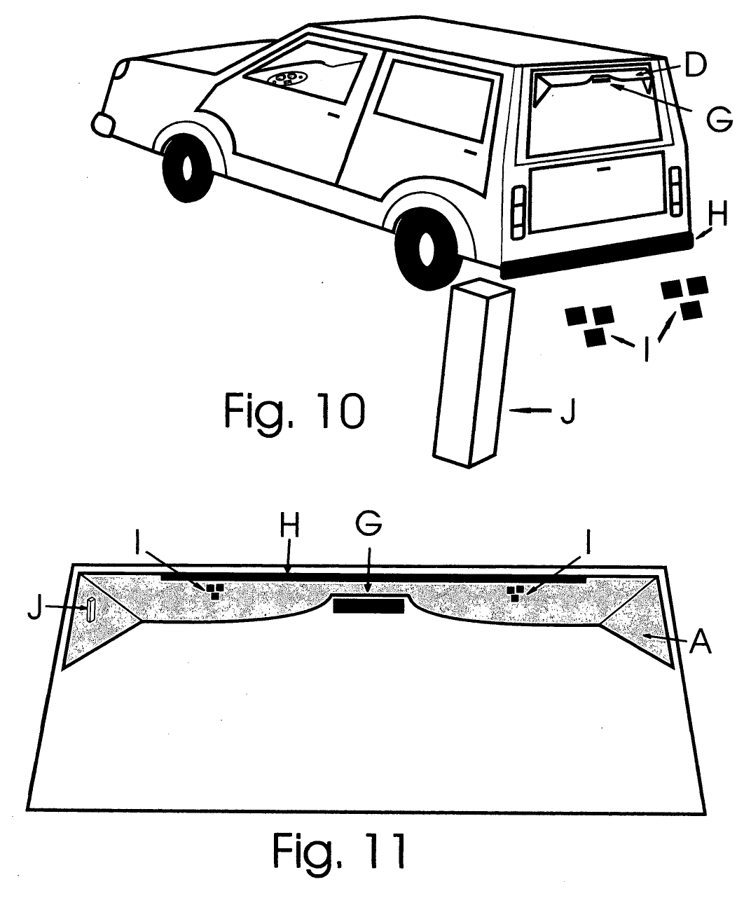

(FIG. 10) a sports utility vehicle with the LRVM, (g) is a brake light. The rear bumper (h), and (i) & (j) are some blocks in the rear of the suv that will be visible from the inside of the truck, illustrated on (FIG. 11).

(FIG. 11) is the rear window as seen from inside of the vehicle, it shows how it looks to the driver, and how it works. The driver can see both the bumper (h) and the blocks (i&j) on the LRVM.

### DETAIL DESCRIPTION OF THE INVENTION

The LRVM is a mechanical device to help drivers see more of the lower rear area of vehicles see (FIG. 10). The LRVM is made in such a way so as not to disincline the use of it, because it won't stand out like other products. The problem is that when drivers are ready to back up, the driver looks back to see if it is clear yet they can't see all of the rear area behind the vehicle. And sometimes there are accidents because of it. The LRVM helps drivers see more of the rear area using the best possible thing one can use, mirrors. (FIG. 10) shows the best placed to put them. The drivers will be able to see if anything, and most important if a small child is in the lower rear area. As the driver backs up, the driver looks backwards and uses the LRVM. Drivers will be able to see and know that they are backing up safely. The driver will be sure and confident they are backing up safely because the driver will actually be seeing the lower area.

The LRVM is a spoiler (d) and mirror (a) combination (FIG. 1-11). Spoilers also known as wing tails, are used on the back of vehicles as an accessory to add a little style, and make the vehicle look nicer. They are mounted on the rear door above the window of mini vans, and suv's. And are also used on cars, mounted on the trunk doors.

The spoiler part of the LRVM (d) seen on (FIGS. 2,6,7,8,10) is shaped to go mainly with the mirror part, and the shape of the rear of the vehicles and windows, as seen on (FIGS. 1,3,4,5,6,9,11). The mirror (a) goes under (d), The spoiler part or the top part or outer shell of the LRVM can be made of various materials like plexiglass, pbc foam plastic, hard plastic, fiberglass . . . The spoiler part is why people won't be reluctant to put and use the LRVM on their vehicle, since it will not look awkward or stand out.

The inner part of the LRVM is the mirror (a) assembly, it is also shaped according to the shape of the vehicle and spoiler part. There are also several ways the mirror part can be made. Shape and style of vehicle will be the main factors of how the mirrors will be made, and shaped. Both are because there are many different makes and models of vehicles with new ones every year, which have and will have different shapes of the rear of the vehicle as well as windows. One way the mirror (a) part will be made, is with the backing of the mirror being much thicker (e)on top side and the bottom side thinner see (FIGS. 1 & 3).

The mirror can be completely flush with the spoiler, separated, or spaced evenly at a certain thickness. Another way the mirror or mirrors can be made are adjustable similarly to the way side view mirrors are adjusted. This will most likely be the way most LRVM's will be made. This is to help maintain the LRVM tilted downward, which makes the spoiler part look better, by not ending up looking too horizontal.

(FIG. 1) shows the LRVM with two adjustable hinges (c) they are for mounting the LRVM above the window, (a)points to the (shaded) mirror part,(a) is on the inner side of the LRVM. (B) indicates that the top part of the mirrors assembly backing, is much thicker, the mirror backing gets thinner towards the bottom. As mention this is one way to keep the LRVM tilted downward.

(FIG. 2) shows a back angle view of (FIG. 1) with the hinges(c). The back side or outer side is (d),this is the spoiler part of the LRVM.

(FIG. 3) shows an angle top inner side view of (FIG. 1) without the hinges (c).

(FIG. 3) give another view to help see how the bevel is thicker at the top, and thinner at the bottom.

(FIG. 4) is an inner view of a same shape LRVM with another example of how the LRVM can be installed. There is an upper lip (e) which is part of the spoiler half, this overlap would be flush (flat) with the windows shape, contain glue to to mount on the window or above the window.

(FIG. 5) is the LRVM with a similar fit as (FIG. 1), but with the top side curved. The curve is to make the LRVM sit well on such vehicles that curve outward.

(FIG. 6) is a back angle view of (FIG. 5), with a convex mirror. The first arrow pointing to the middle shows part of the convex mirror. Convex mirrors assist to get a good view on some vehicles were other mirror assemblies will not work well, mainly because of the shape the rear of the vehicle has.

(FIG. 7) shows a different shape to fit on a different style of vehicle, were the rear windows is almost in a square shape. This shape of window is also found some vans that have two small windows, so instead of using one LRVM two smaller LRVM's would be used, one on each window.

(FIG. 8) is another smaller style of LRVM which can be used on the window of the vans with two small windows, but are actually for vehicle that have a large item in the top center of the window, and the larger LRVM can not be used. Also for the suv's that have two rear doors that open in the middle.

(FIG. 9) is the LRVM shaped to allow the brake light to be seen. On some there is an additional brake light on the top off the window. To be able to use both the LRVM and brake light, the LRVM is shape higher in the middle (f).

(FIG. 10) shows an suv with the LRVM, with the (g) the brake light. Also there are some small squares(i), and a small column (j), (h) the bumper. (J) is position in the rear but off to the left of the vehicle, to show that this area is also visible with the LRVM,( both to the left & right rear). These areas are blinded mostly by other vehicles in parking lots or drive ways. By being able to see these areas, less accidents can also be prevented.

(FIG. 11) this drawing shows what the driver actually sees. This is the rear window from (FIG. 10), (i,j, and h) the squares in the lower rear area, the small column on the side, and the rear bumper are all clearly seen with the LRVM.

The difference between the other current systems to assist in backing up are several. There are alarms that beep while the vehicle in backing up. There are sensors that let the driver know if something is in the rear area There are cameras to show the driver the lower rear area.

There are also some round mirrors, used mostly on the back of commercial vehicles. The cameras, and sensors only cover part of the rear area compare to the LRVM, which shows all of the lower rear and part of the sides, as the items (h-i-j) on (FIGS. 10 and 11) show. The cameras and sensors can also malfunction, and become misleading. The LRVM will give the driver the confidence that is needed, because the LRVM will not malfunction, and the driver knows what he or she is looking at, is there, without a doubt as can be seen on (FIG. 11). With the cameras the drivers must look at a monitor that is in the front, inside the cab. The driver can look at the lower blind areas with the LRVM while he or she is looking backwards, almost simultaneously.

Some drivers are reluctant and disinclined to use any items on the market that assist in reversing a vehicle, because it will somehow make them seem to be incapable of reversing the vehicle without assistance, or give an undesirable and timid feeling from something that will stand out, like the beeping device, and the small round mirrors that stick out and don't look very nice.

The LRVM does not give the sense of not being able to back up without any assistance, and will not shy away drivers from adding and using it, because it will not stand out, or make the driver seem to need the assistance.

What I claim is:

1) that the Lower Rear View Mirror is a reversing device to assist drivers to reverse a vehicle safe, and confident comprising of:
(a) spoiler and mirror combinations.
(b) a reversing device that will add style to vehicles, (as spoilers do) and at the same time will provide the assistance and assurance in reversing a vehicle, that the driver can constantly glance at the Lower Rear View Mirror to see the lower rear area, and off to the right and left of the back from start to finish, and as the driver is looking backwards backing up.
(c) that since the Lower Rear View Mirror is placed on the top of the rear window, and it's concept will not stand out from the ordinary, it will be discreet, easy to use, convenient, attractive, accustom to, and not deter or discourage a driver from it.
